(19) United States
(12) Patent Application Publication
(10) Pub. No.: US 2025/0033928 A1
(43) Pub. Date: Jan. 30, 2025

(54) ELEVATOR SYSTEM HAVING ELEVATOR USAGE RULES AT BUILDING DOOR OPENING

(71) Applicant: Inventio AG, Hergiswil (CH)

(72) Inventor: Florian Trösch, Erlenbach ZH (CH)

(21) Appl. No.: 18/714,070

(22) PCT Filed: Dec. 12, 2022
(86) PCT No.: PCT/EP2022/085377

§ 371 Date: May 28, 2024

(30) Foreign Application Priority Data
Dec. 21, 2021 (EP) 21216516.1

(51) Int. Cl. B66B 1/46; B66B 1/34

(52) U.S. Cl. CPC B66B 1/468; B66B 1/3461; B66B 2201/4615; B66B 2201/4638; B66B 2201/4653

(57) ABSTRACT

An elevator system has an elevator controller, an elevator car, and elevator operating devices, which are communicatively coupled to the elevator controller by a communication network. The elevator controller receives an electrical door signal via the communication network, which indicates that a building door of a building is opening and/or closing. A control and interface device is communicatively coupled to the elevator controller and has a communication device which can be coupled to an external communication network to exchange data with a communication apparatus of a person using the building. The data relate to an elevator usage rule set by the person. The control and interface device can store the elevator usage rule in a memory device and, upon receipt of the door signal, generate a control signal corresponding to the elevator usage rule. The elevator controller can operate the elevator system according to the control signal.

### TECHNICAL FIELD

The disclosure described herein relates generally to an elevator system and the operation thereof in a building. Exemplary embodiments of the disclosure relate to an elevator system in conjunction with a building door and a method for operating such an elevator installation.

### SUMMARY

In a building with an elevator system, elevator operating terminals are arranged on the individual floors with which a user can call an elevator. An elevator operating terminal can have up/down buttons with which a person can input a desired direction of travel on a floor. After boarding an elevator car servicing the elevator call, the person can enter a desired destination floor at a car call terminal arranged in the car. Another floor-side elevator operating terminal can have a keypad, a touch-sensitive screen, and/or a data acquisition device (e.g., in the form of an RFID card reader known from EP 0699617 B1) for call input; such a call input comprises the desired destination floor and is also known as destination call.

Alternatively to inputting an elevator call on an elevator operating device, an elevator call can also be initiated by actuating a building door (e.g., building interior door and/or building exterior door) in conjunction with an electronic or electromechanical door lock. For example, EP 2 271 572 B1 describes a method for operating an elevator system in which a destination call is initiated by opening and/or closing a building door. A door sensor detects the opening and/or closing of the building door, whereupon a door signal is transmitted to an elevator controller. The floor on which the respective building door is arranged defines the call input floor (also boarding floor). As soon as the elevator car has reached the call input floor and the person has boarded, the elevator car is moved to the destination floor according to the destination call.

Known elevator systems have an extensive functionality for transporting passengers safely, comfortably and efficiently (e.g., with respect to wait time and/or travel time) from a boarding floor to a desired destination floor. Building doors with electronic or electromechanical door locks have, in contrast, a limited functionality which is disadvantageous in particular in modern buildings because building users not only expect safety from a building door, but generally also comfort when using the building, including the use of the elevator system. There is therefore a need for a technology to be able to better meet these requirements.

One aspect of the present disclosure relates to an elevator system that can comprise an elevator controller, an elevator car and elevator operating devices which are communicatively coupled to the elevator controller by a communication network. The elevator controller can be designed to receive an electrical door signal via the communication network which indicates that a building door of a building is opening and/or closing. A control and interface device can be communicatively coupled to the elevator controller and comprises a communication device which can be coupled to an external communication network in order to exchange data with a communication apparatus of a person using the building. The data comprise an elevator usage rule defined by the person. The control and interface device can be designed to store the elevator usage rule in a memory device and, upon receipt of the door signal, to generate a control signal corresponding to the elevator usage rule. The elevator controller can be designed to operate the elevator system according to the control signal.

Another aspect relates to a method for operating such an elevator system in a building. According to the method, a door signal transmitted by an elevator controller may be received by a control and interface device of the elevator system. The door signal may be received by the elevator controller via a communication network and may indicate an opening and/or a closing of a building door. In response to the received door signal, an elevator usage rule may be determined by the control and interface device, wherein the elevator usage rule may be stored in a memory device. A control signal may be generated by the control and interface device based on the determined elevator usage rule. The control signal may be transmitted from the control and interface device to the elevator controller, and the elevator system may be operated in a controlled manner by the elevator controller according to the control signal.

According to the disclosure described herein, an elevator system can be created in which a person can define one or more elevator usage rules for a building door which are to apply when this building door is opened, for example. For example, the person can specify in an elevator usage rule how the elevator system should react if they open the apartment door (inside building door) upon leaving his apartment or if they open a front door (outside building door) upon his return home. When leaving the apartment, the elevator usage rule can, for example, establish that an elevator call is generally registered or that this takes place at certain times; for the last-mentioned case, the elevator usage rule can contain corresponding time specifications. Another exemplary elevator usage rule can specify that the elevator system asks the person whether an elevator is required.

The disclosure described herein can make it possible for the person to determine an elevator usage rule which applies individually for them and/or for the building door(s) assigned to them. An elevator usage rule can comprise a time specification for an elevator use, a time specification for an alternative building use (e.g., an errand on the floor of the building door, or the person wants to go to foot to another floor) or an initiation of communication (request) with the person with or without time specification. For a building door (e.g., a building exterior door/house door), an elevator usage rule can comprise a building door-specific elevator use, e.g., that a proof of authorization is to be presented at this building door, and an elevator call is registered in the event of valid proof of authorization.

In one exemplary embodiment, which can be applicable in connection with one or more of the exemplary embodiments mentioned herein, the person can use a mobile communication apparatus (e.g., a cell phone) or a stationary communication device (e.g., a computer) to establish (program) an elevator usage rule, which mobile communication apparatus can communicate with the elevator system via the communication network. The communication network can comprise the Internet and/or a cell communication network; with regard to the building, this is accordingly a communication network which is completely or partially an external communication network. For the communication between the person and the elevator system, no or a minimal building-internal communication infrastructure may therefore to be provided. Accordingly, the communication device of the elevator system can be designed to exchange data with a radio signal or a wired data signal.

If the person wears a mobile communication apparatus when opening the apartment door, the elevator system can send, for example, the aforementioned request to the mobile communication apparatus according to a corresponding elevator usage rule, and the person can respond thereto with an input on the mobile communication apparatus. This communication can be via the building-external communication network.

In one exemplary embodiment, which can be applicable in conjunction with one or more of the exemplary embodiments mentioned herein, the elevator usage rule can be stored centrally in the elevator system and can be executed there. A door sensor which can be communicatively coupled to the elevator system may therefore be provided on a building door. If an electronic or electromechanical door lock is provided on a building door, it can be a technically relatively simple door lock which can be unlocked and locked; in particular, neither a memory device for storing the elevator usage rule nor a communication device for receiving the elevator usage rule may be required.

In addition, a person can store a plurality of elevator usage rules applicable to them centrally in the elevator system. For the person, a personal profile (user profile) can be saved in the elevator system for this purpose. This, along with central storage, can increase operating comfort while programming the elevator usage rules, and the building-specific and person-specific programming of the elevator usage rules, e.g., adapted to the number of building doors that are associated with the person and to the habits of the person.

A plurality of building doors and a plurality of persons that use the building can exist in a larger building. In one exemplary embodiment, the elevator system can be designed to store, manage, and execute the plurality of elevator usage rules in such a building. Correspondingly, the elevator controller can be designed to receive a plurality of door signals, wherein each door signal may be fixedly associated with one of the building doors and may display an opening and/or a closing of this building door. The memory device can be configured to store this assignment to a building door for each door signal and to store an individual elevator usage rule for each of these building doors. The control and interface device can be designed to determine the associated building door and the elevator usage rule for a received door signal.

In one exemplary embodiment, which can be applicable in conjunction with one or more of the exemplary embodiments mentioned herein, the elevator controller can be designed to receive an identification signal from a detection device that is associated with a building door and to check it for validity. The identification signal may be generated if the person has a proof of authorization at this building door, wherein the elevator controller can be designed to transmit the door signal originating from this building door to the control and interface device when there is a valid identification signal. An elevator usage rule can therefore be linked to a condition, for example, that the person has to present a valid proof of authorization at a house door before the building door is opened and an elevator call is registered.

In one exemplary embodiment, which can be applicable in conjunction with one or more of the exemplary embodiments mentioned herein, the memory device can be configured to store the elevator usage rule together with a personal ID in a personal profile. The identification signal that may be generated by the detection device can comprise the personal ID of the person who presents the proof of authorization. The elevator controller can be designed to transmit the personal ID to the control and interface device, and the control and interface device can be designed to determine, based on the transmitted personal ID, the elevator usage rule which may be stored in the personal profile associated with the personal ID.

The disclosure described herein is not limited to a specific control technology; it can be used in an elevator system with a destination call controller and in an elevator system with a conventional up/down direction controller. The disclosure described herein can therefore be used in a plurality of buildings with existing and newly installed elevator systems.

### BRIEF DESCRIPTION OF THE DRAWINGS

Various aspects of the disclosure are described in greater detail herein in conjunction with the drawings with reference to exemplary embodiments. In the figures, identical elements have identical reference signs. In the drawings:

FIG. 1 is a schematic representation of an exemplary situation in a building having a plurality of floors and having an elevator system;

FIG. 2 is a schematic representation of exemplary communication between the elevator system and a mobile device; and

FIG. 3 is an exemplary representation of a method for operating the elevator system.

### DETAILED DESCRIPTION

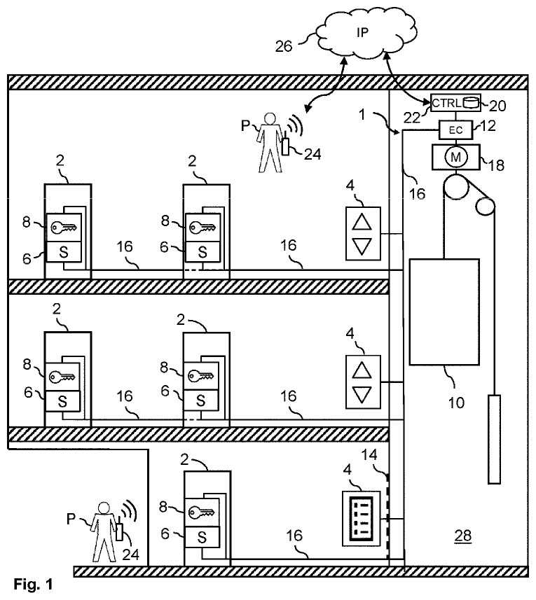

FIG. 1 is a schematic representation of an example of a situation in a building that has a plurality of floors L, L1 that are served by an elevator system 1. In the shown situation, a plurality of building doors 2, for example, apartment doors or house doors, are arranged on the floors. Briefly, and by way of introduction, the elevator system 1 can be designed to react when a building door 2 is opened and/or closed in accordance with an elevator usage rule R1, R2, R3, which a person P has previously defined in advance for “their” building door 2 (or building doors 2). The reaction can consist, for example, of the fact that an elevator is (or also is not) moved onto the floors of the building door 2, or in that the person P who is located at the building door 2 is asked for instructions or is asked to input such instructions. If the person P initiates, for example, an opening of the building door 2, the elevator system 1 can receive a door signal associated with this building door 2, whereupon the elevator system 1 can operate according to the elevator usage rule R1, R2, R3 associated with the door signal. An elevator usage rule R1, R2, R3 can, for example, establish that no elevator is being called when the building door 2 is opened on a Sunday (because the person P would like to use the stairs), and/or that an elevator is being called when the building door 2 is opened in the morning on a workday (because the person P then requires an elevator to an underground garage). Further exemplary embodiments are given herein.

In the illustration shown in FIG. 1, the elevator system 1 is shown in its basic structure. For illustration, an elevator controller 12 (EC), a drive device 18 (M), elevator operating devices 4, and an elevator car 10 movable in a shaft 28, also referred to herein as car 10, are shown. A person skilled in the art recognizes that the elevator system 10 can also be designed differently, for example, as one with a plurality of cars 10 in one or more shafts 28 or as a hydraulic elevator. The shaft 28 is separated on each floor in a known manner by a shaft door 14 (in FIG. 1, the shaft door 14 is indicated only on the lowest floor).

In addition, the elevator system 1 has a control and interface device 22 (CTRL) which comprises a memory device 20 or is communicatively coupled to such a memory device. In the shown exemplary embodiment, the control and interface device 22 is connected to the elevator controller 12; in another exemplary embodiment, the control and interface device 22 or its functionality can be implemented in the elevator controller 12. In the following description of an exemplary embodiment, the control and interface device 22 (as shown in FIG. 1 by way of example) is connected to the elevator controller 12, but without being limited thereto.

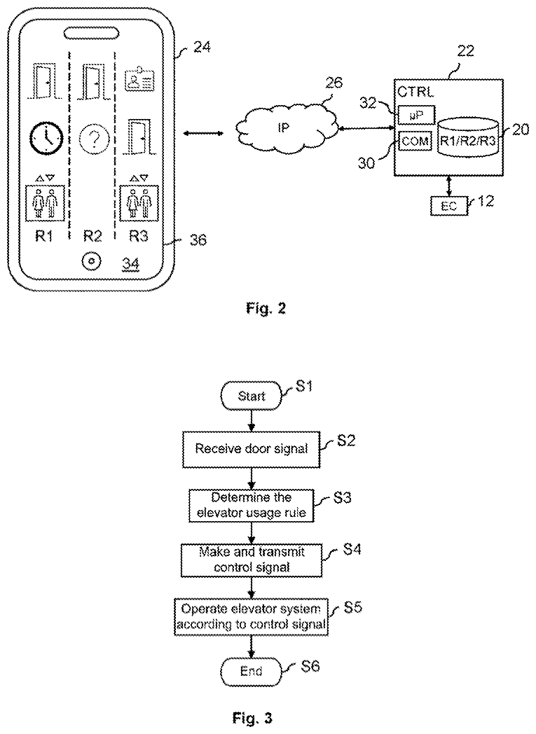

The control and interface device 22 has a communication device 30 (FIG. 2) for communication via a communication network 26 (IP), for example, the Internet; relative to the building and the elevator system 1. The communication network 26 is an external communication network. Via this communication network 26, the control device 22 can receive data from a communication apparatus 24 and transmit it thereto. The communication apparatus 24 can be a mobile communication apparatus (e.g., a cell phone) that is carried by a person P; in this case, communication, at least by the person, can comprise radio communication in accordance with a standard for mobile communication known to a person skilled in the art. The elevator's communication device 30 can also be designed for such radio communication; it can also comprise a wired data communication. In another exemplary embodiment, the communication apparatus 24 can be a stationary computer.

In the situation shown in FIG. 1, the building doors 2 are arranged on the upper floors in the building interior; they allow, for example, access to apartments, offices or other delimited zones or rooms or departure therefrom. A person skilled in the art recognizes that the building door 2 arranged in the lower floor in FIG. 1 can be a building exterior door, for example, a house door or a garage door or a garage gate. Typically, a building door 2 delimits an interior space from an outside space, for example, an apartment door delimits a (private) apartment from a public or semi-public corridor, in a similar manner, a building exterior door delimits the building interior from an outer region, e.g., from a public walkway.

In FIG. 1, each building door 2 has a locking device 8 which can be designed depending on the building (e.g., residential and/or commercial building), type of building door 2 (e.g., swinging door or sliding door) and location of the building door 2 (e.g., interior or exterior door). The locking device 8 can comprise a mechanical or electromechanical door lock which, in one exemplary embodiment, is designed such that a person P can actuate it from both door sides (i.e., from the inside and outside), including opening and closing and/or locking and unlocking the building door 2. In particular for unlocking from the outside, it can be provided that the person should have a mechanical key or proof of authorization (e.g., password or code). Examples of proof of authorization are given elsewhere in this description.

FIG. 1 also shows a plurality of sensor devices 6 which are communicatively connected to the elevator controller 12 by a communication network 16. In the shown exemplary embodiment, each sensor device 6 is assigned to a building door 2 and designed to generate an electrical door signal when the building door 2 is actuated, in particular when opening and/or closing. The assignment to a building door 2 can be accomplished in that the sensor device 6 is arranged on the building door 2 as shown in FIG. 1; it can be arranged on a door leaf, a door frame, and/or in the locking device 8. For this purpose, the sensor device 6 can comprise, for example, a door contact switch. The assignment to a building door 2 can also be accomplished in that a sensor device 6 is arranged in a defined vicinity to a building door 2. The opening and/or closing of the building door 2 can thereby be detected, e.g., with a movement sensor or a surveillance camera as a sensor.

According to one exemplary embodiment, the sensor device 6 detects from which door side (i.e., from the inside or from the outside) the person P actuates the building door 2; this can be achieved, for example, with a combination of the mentioned sensors. The sensor device 6 can be designed, for example, to determine whether the person P touches an inner or an external door handle (or an analogous device); in the case of an apartment door, for example, the internal door handle can cause a door signal; in the case of a building exterior door (house door), it can in contrast be the outer door handle that can cause a door signal. Depending on the embodiment, the sensor device 6 can recognize whether the person P is approaching (or is already there) from the inside or from the outside of the building door 2, or is presenting a proof of authorization. It can therefore be detected whether the building door 2 is opened, e.g., when leaving the apartment, and the person P may need an elevator, or is opened to enter the apartment, and the person P therefore does not require an elevator.

In one exemplary embodiment, which can be used, for example, for an apartment door, the sensor device 6 can be designed to generate a door signal when the building door 2 is closed. When leaving the apartment, the person P can, for example, first open the apartment door and then close and lock it. The sensor device 6 can recognize the leaving of the apartment (direction of movement of the person) from the sequence of the door opening, door closing, door locking. The person P can actively (deliberately) close (lock) the apartment door from the outside. A person skilled in the art recognizes that an apartment door can be locked and should first be unlocked before the person P can open it to leave the apartment. This unlocking can occur automatically, for example, by the locking device 8 when the inner door handle is pressed. The person P can also actively (deliberately) close the apartment door from the inside. The sensor device 6 can be designed to recognize this.

The communication network 16 can comprise a communication bus system, individual point-to-point lines, or a combination thereof. Depending on the implementation of the communication network 16, individual addresses and/or IDs can be allocated to the elevator controller 12, the elevator operating devices 4, the building doors 2, or their sensor devices 6. Communication can take place in accordance with a protocol for wired communication, for example, the Ethernet protocol. With the mentioned addressing or the point-to-point line connection, the elevator controller 12 (e.g., in conjunction with a building plan) can recognize inter alia which building door 2 is open or closed on which floor. The floor on which the recognized building door 2 is arranged specifies the location of the person P and therefore a boarding location (boarding floor) for a possibly desired journey to a destination floor.

FIG. 2 is a schematic representation of an exemplary communication between the control and interface device 22 of the elevator system 1 and the mobile communication apparatus 24. Via the communication network 26, the control and interface device 22 and the communication apparatus 24 communicate with one another bidirectionally, i.e., both units can receive and transmit data via the communication network 26.

The control and interface device 22 shown by way of example in FIG. 2 comprises the communication device 30, a processor 32 (μP) and a memory device 20 which is communicatively coupled to the communication device 30. The processor 32 is designed (e.g., programmed) to execute the functions of the control and interface device 22. According to these functions, the control and interface device 22 can, inter alia, receive data from the elevator controller 12, process it, transmit a subsequently generated control signal to the elevator controller 12, store one or more elevator rules R1, R2, R3 in the memory device 20 and read and process it.

The mobile communication apparatus 24 is shown in FIG. 2 by way of example as a cell phone or smartphone of the person P. The mobile communication apparatus 24 has a display unit 36, inter alia, for operating the mobile communication apparatus 24 with a graphical user interface 34. The user interface 34 in FIG. 2 shows by way of illustration three elevator usage rules R1, R2, R3 in three columns arranged next to one another. The person P can view the elevator usage rules R1, R2, R3 shown in FIG. 2, for example, in order to obtain an overview of the already established elevator usage rules R1, R2, R3, modify them, and/or to add a further elevator usage rule. A person skilled in the art recognizes that the number of elevator usage rules R1, R2, R3 depends on the person P (they can have defined one or more elevator usage rules R1, R2, R3, for example), and that the elevator usage rules R1, R2, R3 can be displayed in a different manner, e.g., one elevator usage rule R1, R2, R3 per individual view, wherein the person P can “scroll” between the individual views.

The elevator usage rules R1, R2, R3 are represented by symbols/pictograms; a person skilled in the art recognizes that they are exemplary and can additionally or alternatively comprise text, individual letters and/or numbers. A person skilled in the art also recognizes that an analog user interface 34 can be displayed on a monitor of a stationary or mobile computer. The mobile communication apparatus 24 (or the computer) can have a software application (app) which makes it possible for the person P to establish (to program) the elevator usage rules R1, R2, R3. For example, the software application on the user interface 34 can generate one or more fields for inputting and/or selecting, for example, personal information, access authorizations, contact information, information on building doors, elevator actions, time specification (e.g., time of day, time period, weekday), and/or directions of travel or destination floors (possibly in conjunction with time specifications) by the person P. After completion of the programming of an elevator usage rule R1, R2, R3, the software application can initiate its transmission to the control and interface device 22 which stores the elevator usage rule R1, R2, R3 in the memory device 20.

According to the exemplary elevator usage rules R1, R2, R3 shown FIG. 2, the elevator system 1 is operated as follows:

The elevator usage rule R1 specifies an action at a defined building door 2 (pictogram for an open door), a time specification (pictogram for a clock) and an elevator action (pictogram for an elevator). If the person P has specified this elevator usage rule R1 for example for their apartment door, this means that an elevator call is registered when the apartment door (defined building door 2) is opened at a specified time. The door opening is indicated to the elevator controller by the generated door signal. The specified time can indicate an approximate time (e.g., in the morning at 7:30 am+/−5 minutes), a time period (e.g., in the morning on a workday between 7:00 and 9:00 am). Depending on the control technology used in the elevator system 1 (see herein), the elevator call can, for example, indicate just the direction of travel or the direction of travel and a desired destination floor.

The elevator usage rule R2 also defines an action on a defined building door 2 (pictogram for an open door), for example, also the apartment door of the person P. According to this elevator usage rule R2, the elevator system 1 should react to a door opening with a request (pictogram for a request (shown in FIG. 2 as a question mark)) which the elevator system 1 sends to the mobile communication apparatus 24 of the person P. The request can be sent as a request message. When programming the elevator usage rule R2, to do this, the person P has, for example, entered the telephone number of the communication apparatus 24, so that the communication regarding the request takes place via the communication network 26. The request can, for example, ask whether an elevator is desired; depending on the embodiment, the direction of travel or a destination floor can be requested. The software application is designed to accordingly display the request on the user interface 34, including possibly input and/or selection fields. A person skilled in the art recognizes that the elevator usage rule R2 can also contain time specification in one exemplary embodiment. The person P can, for example, specify that the request is to take place when the building door 2 is opened at the weekend.

The elevator usage rule R3 specifies that a proof of authorization (pictogram for an image ID) should be provided at a defined building door 2. This can be necessary, e.g., to the building entrance door (house door), which is shown on the lowest floor in FIG. 1. The elevator usage rule R3 also specifies that an elevator call should be registered (pictogram for an elevator) for the person P, who identifies themselves as authorized by the proof of authorization. Depending on the control technology used in the elevator system 1 (see herein), the elevator call can, for example, indicate just the direction of travel or the direction of travel and a desired destination floor. For example, the (stored) destination floor can be the residential floor to which the person P would like to be transported after they have returned home.

A person skilled in the art recognizes that the locking device 8 of the building entrance door can be designed to detect the proof of authorization and to initiate a validity check. The locking device 8 can comprise a detection device (also identified with the reference sign “8”) which can generate an identification signal when a proof of authorization is presented. The validity check can be performed by an access control function which is executed in an access control system provided in the building or in the elevator controller 1 or in its control and interface device 22. The proof of authorization can be designed in one of the ways mentioned herein. In one exemplary embodiment, the proof of authorization is stored on the mobile communication apparatus 24. If the person P is located at or in the vicinity of the building entrance door, the mobile communication apparatus 24 can transmit the proof of authorization (or its data) to the locking device 8 in one exemplary embodiment as a radio signal (e.g., according to RFID or Bluetooth technology). The elevator controller 12 is designed in one exemplary embodiment to transmit the door signal originating from the building door 2 to the control and interface device 22 when the identification signal or proof of authorization is valid.

The memory device 20 can be designed to store the elevator usage rule R1, R2, R3 together with a personal ID in a personal profile. The identification signal can comprise a personal ID that uniquely identifies the person P. The elevator controller 12 can be designed to transmit the personal ID to the control and interface device 22. Based on the transmitted personal ID, the control and interface device 22 can be designed to determine the elevator usage rule R1, R2, R3 which is stored in the personal profile associated with the personal ID.

With the understanding of the basic system components and their functionalities described herein, a description of an exemplary method for operating the elevator installation 1 is given herein with reference to FIG. 3. The elevator system 1 and the building are designed as shown by way of example in FIG. 1. In FIG. 3, the method is shown with an exemplary flowchart with a number of steps. A person skilled in the art will recognize that the division into these steps is by way of example, and that one or more of these steps may be divided into one or more sub-steps, or that several of the steps may be combined into one step. Some steps can also be performed in a different order than shown, and some steps can be performed substantially simultaneously.

The method according to FIG. 3 begins with a step S1 and ends with a step S6. In a step S2, a door signal is received which is associated with a building door 2. As explained in conjunction with FIG. 1, the door sensor 6 may generate the door signal when the building door 2 is opened by or for the person P. In one exemplary embodiment, the door signal is addressed to the elevator controller 12 in order to be transmitted via the communication network 16 to the elevator controller 12. The building door 2 or its door sensor 6 from which the door signal originates is determined from this transmission with transmitter and receiver information, i.e., it is recognized which building door 2 is opened. In addition, this also yields the time (e.g., weekday and time of day) at which the door signal is received.

With this information, it is possible to determine the person P who is authorized to access at this building door 2; the floor on which the building door 2 is arranged can also be determined. The arrangement of the building doors 2 can be documented in an electronically stored building plan from which the elevator controller 12 and/or the control and interface device 22 can read data. The aforementioned determinations can be carried out by the elevator controller 12 and/or the control and interface device 22. The door signal received by the elevator controller 12 and/or the information (building door 2, person P, floor) determined by the elevator controller 12 can be transmitted to the control and interface device 22 for this purpose.

In a step S3, an elevator usage rule R1, R2, R3 is determined. To accomplish this, the control and interface device 22 may use the information determined in step S2 to search the memory device 20, controlled by the processor 32, for an elevator usage rule R1, R2, R3 associated with the door signal or the building door 2, which is to be applied at the determined time. In the exemplary embodiment described herein, it is assumed that the person P has defined at least one elevator usage rule R1, R2, R3. However, it is also possible that the person P has not defined an elevator usage rule R1, R2, R3 in general or for a specific building door 2. In this case, the elevator system 1 can be designed so that an elevator call is registered upon each door opening. Alternatively, there can be no reaction by the elevator system 1 to the door opening. Depending on the building door 2 and/or the point in time, the control and interface device 22 may determine the elevator usage rule R1, R2, R3 that is to be applied to the present building door 2.

Based on the determined elevator usage rule R1, R2, R3, the control and interface device 22 generates a control signal in a step S4 according to which the elevator system 1 is to operate in a step S5. The elevator system 1 may operate in response to the door signal originating from a recognized building door 2. The response can include a response that is determined in accordance with one of the elevator usage rules R1, R2, R3 described in connection with FIG. 2 (e.g., registering an elevator call or sending a request to the mobile communication apparatus 24). The method ends at step S6.

Further details of the elevator system 1 are indicated herein. Reference is again made to the situation shown in FIG. 1.

The elevator installation 1 can be equipped with an up/down controller (also direction controller) or a destination call controller, for example. A person skilled in the art recognizes that mixed forms of the aforementioned control technologies can also be possible. If the elevator system 1 is equipped with an up/down controller, elevator operating devices 4 can be arranged on the floors on each of which an elevator call (also floor call or direction call) can be input for a desired direction of travel. By way of illustration, such elevator operating devices 4 are shown in FIG. 1 on the two upper floors. The desired destination floor can then be input by the person P in the car 10 at an elevator operating device arranged there (not shown in FIG. 1). Such a call input is also referred to as a car call. A communication line connects the (car-side) elevator operating device to the elevator controller 12. The drive controller 18 controls the travel of the elevator car 10 according to the destination floor input in the car 10. If the elevator system 1 is equipped with a destination call controller, elevator operating devices 4 can be arranged on the floors on which a person P can enter a desired destination floor, a destination call is then registered as an elevator call. By way of illustration, such an elevator operating device 4 is shown in FIG. 1 on the lowest floor. After entering the destination floor, information about the entry floor and the destination floor can be available. The drive controller 18 can control the travel of the elevator car 10 according to the destination call.

In one exemplary embodiment, the communication network 16 serves for bidirectional communication between the individual elevator operating devices 4 and the elevator controller 12. The communication network 16 also serves to communicate between the elevator controller 12 and the individual building doors 2, or their door sensors 6 and closing devices 8. The communication between the elevator controller 12 and the building door 2 can also be bidirectional, for example, for transmitting a control signal for opening (unlocking) a building door 2 after a verification of a proof of authorization.

In one exemplary embodiment, the communication network 16 consists of a wired data bus system. When using such a data bus system, communication between the elevator controller 12 and the elevator operating devices 4 can take place according to a protocol for wired communication, for example, the LonTalk protocol, if the data bus system is based on the LON standard (LON: local operating network). A person skilled in the art will also recognize that, as an alternative to a data bus system, each elevator operating device 32 can be connected to the elevator controller 12 via a separate cable.

For example, a card-shaped data carrier with (RFID) radio technology or a printed optical code (e.g., barcode, QR code, or another matrix code), a password, a code (PIN code) or the mobile communication apparatus 24, which emits an access code or displays an optical code on a display device using a corresponding software application and possibly equipped with RFID or Bluetooth technology, can serve as proof of authorization. Depending on the proof of authorization used in the building, corresponding detection devices 8 may be arranged in the building, in particular, on one or more building doors 2 and in conjunction with the elevator system 1 (floor-side and/or car-side).

Such a detection device 8 can detect the proof of authorization or its data, e.g., a PIN code entered by the person, or an electronic or optical code read from a data carrier when the person P desires entrance at a building door 2. Once the data has been recorded, the system can check whether the received code is assigned to an authorized person P in a database (e.g., in the memory device 20). If this is the case and the person P is therefore authorized to enter, the access control function may cause the affected building door 2 to be unlocked in order to grant the person P entrance.

The recognition device 8 can comprise a reader that can capture data based on one of various known technologies. For example, the reading device can read data from magnetic cards, chip cards, RFID cards or mobile electronic devices (e.g., cell phones, smartphones, tablets), or capture data from optical codes (barcodes, QR codes, color codes) that are printed on various carrier materials or displayed on displays of mobile electronic devices (e.g., cell phones, smartphones, tablets). In another exemplary embodiment, the reading device can comprise a device for capturing and/or recognizing biometric parameters (e.g., patterns of fingertips, palms or eyes (iris), or characteristics of voices). Irrespective of the type of reading device, the data acquisition device can be used, for example, on the door 2.

If radio frequency identification (RFID) technology is used in the reading device, for example, then the reading device can be an RFID reader which receives data from an RFID card placed within radio range. The data, comprising an identification code, for example, can be stored in a data store of the RFID card. The radio frequency used by the RFID reader and the RFID card can be 125 kHz, 13.56 MHz or 2.45 GHz, for example. On the other hand, if an optical technology is used, the reading device can be an optical reading device (e.g., a camera or a scanner) which captures the sample of an optical code that is printed on a carrier material or which is displayed on an electronic device.

In the exemplary embodiment shown in FIG. 1, the building doors 2 provide access to the apartments, offices or other restricted access zones. A person skilled in the art will recognize that in other exemplary embodiments, barriers, turnstiles, revolving doors or other barriers can be used to allow or block access. In further exemplary embodiments, barriers of this kind can be supplemented or replaced by electronic monitoring devices, for example, light barriers, motion sensors or optical devices (3D cameras, video cameras). Depending on the building, alternatives of this kind can also be used in combination.

1-14. (canceled)

15. An elevator system comprising:
an elevator controller;
an elevator car;
elevator operating devices communicatively coupled to the elevator controller by a communication network, wherein the elevator controller is configured to receive a door signal via the communication network, which indicates that a building door of a building is opening and/or closing; and
a control and interface device communicatively coupled to the elevator controller comprising:
a communication device which is configured to be coupled to an external communication network in order to exchange data with a communication apparatus of a person using the building, wherein the data comprise an elevator usage rule set by the person,
wherein the control and interface device is configured to store the elevator usage rule in a memory device and, upon receipt of the door signal, to generate a control signal corresponding to the elevator usage rule, and
wherein the elevator controller is configured to operate the elevator system according to the control signal.

16. The elevator system of claim 15, wherein the memory device is configured to store a plurality of elevator usage rules for the person.

17. The elevator system of claim 15, wherein the elevator usage rule comprises at least one of:
a first time specification for an elevator use;
a second time specification for an alternative building use;
an initiation of communication with the person with or without a time specification; or
a building door-specific elevator use,
wherein, in the case of the elevator use specified in the elevator usage rule, the elevator controller is configured to register and operate an elevator call, wherein the elevator call indicates a direction of travel and/or a destination floor, and
wherein the first time specification comprises a first time, a first time period, and/or a first weekday
wherein the second time specification comprises at least one of a second time, a second time period, or a second weekday.

18. The elevator system of claim 15, wherein the control and interface device is configured to determine a location of the building door based on the door signal and to determine a boarding floor based on the location.

19. The elevator system of claim 15, wherein the communication device is configured to exchange the data with a radio signal or a wired data signal.

20. The elevator system of claim 15,
wherein the elevator controller is configured to receive a plurality of door signals, wherein each door signal is fixedly associated as an assignment with one building door of a plurality of building doors and displays an opening and/or a closing of the one building door of the plurality of building doors,
wherein the memory device is configured to store the assignment to the one building door of the plurality of building doors for each door signal, to store an individual elevator usage rule, for each of the one building door of the plurality of building doors, and
wherein the control and interface device is configured to determine the one building door of the plurality of building doors and the elevator usage rule for a received door signal.

21. The elevator system of claim 15, wherein the elevator controller is configured to receive an identification signal from a detection device that is associated with the building door, and to check it for validity, wherein the identification signal is generated if the person has a proof of authorization at the building door, and wherein the elevator controller is configured to transmit the door signal originating from the building door to the control and interface device when the identification signal is valid.

22. The elevator system of claim 21, wherein the memory device is configured to store the elevator usage rule together with a personal ID in a personal profile, wherein the identification signal comprises the personal ID, wherein the elevator controller is configured to transmit a transmission of the personal ID to the control and interface device, and wherein the control and interface device is configured to determine, based on the transmission of the personal ID, the elevator usage rule which is stored in the personal profile associated with the personal ID.

23. The elevator system of claim 16, wherein the elevator usage rule comprises at least one of:
a first time specification for an elevator use;
a second time specification for an alternative building use;
an initiation of communication with the person with or without a time specification; or
a building door-specific elevator use,
wherein, in the case of the elevator use specified in the elevator usage rule, the elevator controller is configured to register and operate an elevator call, wherein the elevator call indicates a direction of travel and/or a destination floor, and
wherein the first time specification comprises a first time, a first time period, and/or a first weekday
wherein the second time specification comprises at least one of a second time, a second time period, or a second weekday.

24. The elevator system of claim 16, wherein the control and interface device is configured to determine a location of the building door based on the door signal and to determine a boarding floor based on the location.

25. The elevator system of claim 16, wherein the elevator controller is configured to receive an identification signal from a detection device that is associated with the building door, and to check it for validity, wherein the identification signal is generated if the person has a proof of authorization at the building door, and wherein the elevator controller is configured to transmit the door signal originating from the building door to the control and interface device when the identification signal is valid.

26. The elevator system of claim 25, wherein the memory device is configured to store the elevator usage rule together with a personal ID in a personal profile, wherein the identification signal comprises the personal ID, wherein the elevator controller is configured to transmit a transmission of the personal ID to the control and interface device, and wherein the control and interface device is configured to determine, based on the transmission of the personal ID, the elevator usage rule which is stored in the personal profile associated with the personal ID.

27. A method for operating the elevator system of claim 15 in the building, comprising:
receiving the door signal transmitted from the elevator controller with the control and interface device of the elevator system, wherein the door signal is received by the elevator controller via the communication network and displays an opening and/or a closing of the building door for the person;
determining the elevator usage rule with the control and interface device in response to the door signal received, wherein the elevator usage rule is stored in the memory device;
generating the control signal with the control and interface device, wherein the control signal is generated based on the elevator usage rule determined;
transmitting the control signal to the elevator controller with the control and interface device; and
operating the elevator system controlled by the elevator controller according to the control signal.

28. The method of claim 27, wherein the elevator usage rule comprises at least one of:
a first time specification for an elevator use by the person;
a second time specification for an alternative building use by the person;
an initiation of communication with the person with or without the first time specification and/or the second time specification; or
a building door-specific elevator use,
wherein, when the elevator car is used as specified in the elevator usage rule, an elevator call is registered and operated by the elevator controller, wherein the elevator call indicates a direction of travel and/or a destination floor, wherein a location of the building door is determined on the basis of the door signal, and wherein an entry floor is determined on the basis of the location, and
wherein a registration of the elevator call is omitted in the alternative building use.

29. The method of claim 28, further comprising generating the control signal according to the first time specification and respective operation of the elevator system, wherein the first time specification comprises at least one of a time of day, a time period, or a weekday.

30. The method of claim 28, wherein the initiation of communication with the person comprises sending a request message from the communication device of the elevator system to the communication apparatus of the person via the external communication network, wherein a response signal sent by the communication apparatus of the person is received by the communication device of the elevator system via the external communication network.

31. The method of claim 28, further comprising receiving an identification signal and checking for validity in the building door-specific elevator use, wherein the identification signal is generated by a recognition device which is assigned to the building door if the person presents proof of authorization at the building door, and wherein the door signal emanating from the building door is transmitted to the control and interface device if the identification signal is valid.

32. The method of claim 31, wherein the identification signal comprises a personal ID, wherein the personal ID is transmitted to the control and interface device, and wherein, based on the personal ID transmitted, the elevator usage rule is determined which is stored in a personal profile associated with the personal ID.

33. The method of claim 28, further comprising generating the control signal according to the second time specification and respective operation of the elevator system, wherein the second time specification comprises at least one of a time of day, a time period or a weekday.

34. The method of claim 29, wherein the initiation of communication with the person comprises sending a request message from the communication device of the elevator system to the communication apparatus of the person via the external communication network, wherein a response signal sent by the communication apparatus of the person is received by the communication device of the elevator system via the external communication network.
